(19) United States
(12) Patent Application Publication
(10) Pub. No.: US 2026/0298017 A1
(43) Pub. Date: Oct. 1, 2026

(54) PLUG CONNECTOR AND PLUG CONNECTION

(71) Applicant: Ralf M. KRONENBERG, Haan / Rhld. (DE)

(72) Inventor: Ralf M. KRONENBERG, Haan / Rhld. (DE)

(21) Appl. No.: 19/478,540

(22) PCT Filed: Apr. 15, 2024
(86) PCT No.: PCT/EP2024/060184

§ 371 Date: Oct. 24, 2025

(30) Foreign Application Priority Data
Apr. 26, 2023 (DE) 20 2023 102 210.3
Mar. 12, 2024 (DE) 10 2024 107 054.4

(51) Int. Cl. E06B 3/667; E06B 3/663

(52) U.S. Cl. CPC E06B 3/667; E06B 3/66342

(57) ABSTRACT

A plug connector (1) for hollow profiles (2), in particular warm edge hollow profiles, of a spacer (3) of an insulated glazing unit (4), wherein the plug connector has a longitudinal direction (5), a connector center (6) and connector shanks limbs (7, 8) extending longitudinally in both directions from said connector center. The plug connector has, at least in parts, a substantially U-shaped cross section with preferably open ends (11), and has a hollow interior (12) at the inside. The plug connector includes a connector base (9) at its bottom side and side walls (10, 10′) which adjoin longitudinal edges of the connector base at both sides, project upwardly transversely with respect to the main plane of the connector base and each have an outer side (16) and an inner side (16′) which faces the interior, wherein one or both side walls is/are hollow and, at the open bottom.

### CROSS REFERENCE TO RELATED APPLICATIONS

This application is a United States National Phase Application of International Application PCT/EP2024/060184, filed Apr. 15, 2024, and claims the benefit of priority under 35 U.S.C. § 119 of German Applications 20 2023 102 210.3, filed Apr. 26, 2023 and 10 2024 107 054.4, filed Mar. 12, 2024, the entire contents of which are incorporated herein by reference.

### TECHNICAL FIELD

The invention relates to a plug connector and a plug connection for hollow profiles of a spacer in insulating glazing, wherein the plug connector has a longitudinal direction as well as a connector center and, extending therefrom on both sides, longitudinally extended connector shanks.

### BACKGROUND

Such a plug connector is known from DE 103 46 306 A1. It comprises an essentially U-shaped cross-section with open front sides and is formed by a lower connector bottom and, adjoined to the longitudinal edges thereof, hollow sidewalls protruding upward transversely to the main plane of the connector bottom. The identical designed sidewalls each comprise protruding lamellar-shaped resilient restraining elements on their undersides, which extend beyond the bottom outer side of the connector bottom.

EP 1 911 924 A2 shows a U-shaped plug connector with a connector bottom and solid sidewalls of identical design, whereby the plug connector comprises coarse corrugations on the connector bottom and sawtooth-shaped ribs with sharp teeth tips on both the outer sides and upper sides of the sidewalls. This is intended to prevent chip formation when the hollow profiles are plugged in.

DE 20 2010 006 292 U1 discloses a similar plug connector.

DE 10 2013 105 092 A1 concerns a U-shaped straight plug connector with solid sidewalls, one sidewall of which comprises flexible, thin lamellae projecting at an angle on the outer side, and the other sidewall of which comprises rigid ribs on the outer side. A similar U-shaped straight plug connector with right-angled restraining arms instead of lamellae is known from DE 10 2022 112 248 A1.

DE 10 2011 055 539 A1 shows a U-shaped straight plug connector with uniformly designed, solid sidewalls and a substantially flat connector bottom, wherein the sidewalls each comprise a flat outer side and wedge-shaped elevations on the free upper front edge. In the connector center, a protruding abutment rib is arranged on the connector bottom and on the sidewalls.

Other U-shaped plug connectors with a connector bottom and sidewalls are known from practice, on the outer side of which several laterally protruding, straight or round-bent, thin-walled lamellae are arranged individually one behind the other at a distance. In contrast to ribs, the thin-walled lamellae retain their wall thickness over the entire length of the lamellae.

### SUMMARY

The object of the present invention is to provide an improved plug connector and plug connection.

The invention solves this problem with features according to this disclosure.

The claimed plug connector and the associated plug connection between hollow profiles and the plug connector, as well as insulating glazing equipped with it, have various advantages.

The claimed plug connector comprises a longitudinal direction and a connector center, and, extending from this on both sides, longitudinally extending connector shanks, wherein the plug connector has, at least in some areas, a substantially U-shaped cross-section with preferably open front sides and an internal hollow interior space. The plug connector may comprise a connector bottom on its underside and sidewalls adjoining its longitudinal edges on both sides, protruding upward transversely to the main plane of the connector bottom, each with an outer side and an inner side facing the interior space. At least one sidewall may be hollow and may comprise projecting, preferably lamellar-shaped, resilient lower restraining elements on its open underside, which project beyond a bottom outer side of the connector bottom. The connector center refers to the longitudinal extension of the plug connector.

The connector bottom and sidewalls form the U-shape of the plug connector. Its sides are designated as follows. The underside of the plug connector is located on the connector bottom, and the top of the plug connector is arrange at the free edges of the sidewalls facing away from the connector bottom. The sides of the plug connector refer to the outer sides of the sidewalls. The height of the plug connector refers to the extension between the top and underside and in the direction transverse to the main plane of the connector bottom. The width of the plug connector refers to the extension transverse to the longitudinal axis or longitudinal direction and along the main plane of the connector bottom.

In a first aspect of the invention, the plug connector may comprise a corrugated rib contour extending in its longitudinal direction and projecting laterally, with each rib crest being flattened at an angle, which is arranged on the outer side of at least one sidewall of the plug connector.

The corrugated rib contour can compensate for lateral tolerances and ensure secure yet gentle retention in the plugged-on hollow profiles. This is particularly advantageous for mechanically sensitive warm edge hollow profiles. This also applies to other types of hollow profile spacer profiles for insulating glazing, e.g., hollow profiles made of plastic, light metal, stainless steel, or similar materials.

In one advantageous variant, both sidewalls of a U-shaped plug connector have such a corrugated rib contour on their outer side. In another variant, only one sidewall has the corrugated rib contour on its outer side. The first variant has advantages for plug connectors with a larger width of, for example, 14 mm or more. The second variant is advantageous for narrower plug connectors with a smaller width of, for example, 12 mm or less. The second variant can also be used for wider plug connectors.

The slanted, flattened rib crests of the corrugated rib contour are particularly advantageous for a secure fit and lateral tolerance absorption of the plug connector in the hollow profiles attached to both sides of the connector legs. The slanted flattenings of the rib crests have a different and better effect than the previously known sawtooth-shaped ribs with sharp tooth tips.

The corrugated rib contour can extend along the length of the connector shanks. It can be interrupted in the area of the connector center and a potential center stop located there. These outer sides and the preferably double-sided corrugated rib contours can form the lateral sides of the connector.

In a second independent aspect of the invention, the plug connector may comprise further elastic restraining elements which are arranged on the upper free edge area of one sidewall or both sidewalls, away from the connector bottom, and which preferably protrude from this edge area in a direction transverse to the main plane of the connector bottom. The aforementioned laterally projecting corrugated rib contour with individually slanted and flattened rib crests in accordance with the first aspect of the invention may be present on one or both side walls or may be absent on both side walls.

Such a plug connector according to the second independent aspect of the invention can be provided and designed for hollow profiles, in particular warm edge hollow profiles, by a spacer of an insulating glazing, wherein the plug connector comprises a longitudinal direction and a connector center and, longitudinally extending from this center on both sides, connector shanks. The plug connector may have, at least in some areas, a substantially U-shaped cross-section with preferably open front sides and an internal hollow interior space. The plug connector may comprise a connector bottom on its underside and side walls adjoining its longitudinal edges on both sides, which protrude upward transversely to the main plane of the connector bottom, each with an outer side and an inner side facing the interior space, wherein one or both sidewalls are hollow and comprise/comprises projecting, preferably lamellar-shaped, resilient lower restraining elements on its open underside, which project beyond a bottom outer side of the connector bottom. One or both sidewalls may each have further elastic upper restraining elements on their upper free edge area facing away from the connector bottom, which preferably protrude transversely to the main plane of the connector bottom.

The claimed plug connector may have uniformly designed hollow sidewalls of the aforementioned type. In a third independent aspect of the invention, the plug connector may have sidewalls that are designed differently.

Such a plug connector according to the third independent aspect of the invention can be provided and designed for hollow profiles, in particular warm edge hollow profiles, by a spacer of an insulating glazing, wherein the plug connector comprises a longitudinal direction and a connector center and, longitudinally extending from this center on both sides, connector shanks. The plug connector may have, at least in some areas, a substantially U-shaped cross-section with preferably open front sides and an internal hollow interior space. The plug connector may comprise a connector bottom on its underside and sidewalls adjoining its longitudinal edges on both sides, which protrude upwards transversely to the main plane of the connector bottom, each with an outer side and an inner side facing the interior space, wherein one or both sidewalls are hollow and comprises/comprise projecting, preferably lamellar-shaped, resilient lower restraining elements on their open underside, which project beyond a bottom outer side of the connector bottom. The sidewalls of this plug connector may be designed differently.

For example, one sidewall can be hollow with restraining elements on the bottom, and the other sidewall can be solid and without restraining elements on the bottom. The other solid sidewall then does not have the cavity of the one sidewall.

The aforementioned laterally projecting corrugated rib contour with slanted, flattened rib crests in accordance with the first aspect of the invention may be present on one or both side walls or may be absent from both side walls.

In a plug connector according to the third independent aspect of the invention, one or both sidewalls may have additional elastic upper restraining elements on their upper free edge area facing away from the connector bottom, which preferably protrude transversely to the main plane of the connector bottom. Such additional elastic upper restraining elements may also be omitted or may only be present on one sidewall.

In the second and third aspects of the invention, it is alternatively possible that one or both of the sidewalls have a different configuration on their outer side instead of the aforementioned rib contour, whereby the outer side has, for example, a different type of restraining elements, e.g., lamellae projecting at an angle, spring arcs, roughened friction surfaces, or the like, or restraining elements are missing.

The three aspects of the invention can be used advantageously individually and independently of each other or together. The further embodiments of the aspects of the invention can accordingly be used individually and independently of each other or together. The three aspects of the invention are not limited to the aforementioned advantageous connector widths.

The claimed plug connector is suitable for different types of hollow profiles of a spacer in insulating glazing, and is particularly well suited for highly thermally insulating warm edge hollow profiles. Other types of such hollow profiles may involve less strongly or differently insulated variants, e.g., aluminum or steel profiles, which may be extruded, drawn, cast, or rolled, for example.

The first aspect of the invention, with the corrugated rib contour projecting laterally and the rib crests flattened at an angle, has the advantage that the angled flattenings can slide onto the adjacent inner wall of the respective hollow profile that has been attached. They can also gently abut against the inner wall in a frictional connection. Furthermore, they can engage with the inner wall with a form fit if necessary. The slanted flattening areas can act as run-up ramps that protect the sliding hollow profile material and do not overload it at specific points or subject it to excessive pressure. Any form-fitting engagement with the inner wall may be less aggressive than with a sawtooth tip. The retention can be improved and optimized in several ways.

The flattening of the corrugated ribs located in the crest area can be directed along the connector shanks in the longitudinal direction of the connector and toward the connector center, rising outward at an angle. It can form a sloping sliding surface and contact surface for the hollow profile attached from the front side. This is advantageous for accommodating any width tolerances of the plug connector and/or hollow profile in the lateral direction along the main plane of the connector bottom.

The slanted flattening can be arranged between a rib front facing the adjacent front side of the plug connector, rising from the outer side of the relevant sidewall, and a rib ridge of the corrugated rib facing the connector center and sloping downwards towards the outer side. The outer contour of the corrugated rib can thus be divided into three or more different areas. An upright edge can be arranged at each of the transitions. This edge can extend transversely to the main plane of the connector bottom.

In particular, the rear edge located toward the connector center may have a more sharply defined edge shape, which may be advantageous for a retention effect on the adjacent hollow profile inner wall. The angle enclosed between the rib ridge and the flattening can be approximately 90°. This angle can be larger than that of a pointed sawtooth, which can be advantageous for a form-fitting engagement with the inner wall of the contacted hollow profile that is gentle on the hollow profile material.

The front edge facing the front side may be less pronounced or rounded, which is beneficial for easy sliding, for lateral tolerance adjustment, especially in the case of undersize, and for possible material removal.

The rib front, the flattening, and the rib ridge of the corrugated rib can have different angles of inclination relative to the outer side of the respective sidewall. The preferably essentially flat flattening can have a smaller angle of inclination than the rib front. This is advantageous for the aforementioned sliding and lateral contact as well as tolerance absorption. The claimed asymmetrical shape of the corrugated ribs is also advantageous for this purpose.

The single-sided or double-sided lateral corrugated rib contour can yield and deflect as needed when the hollow profiles are attached to the connector shanks of the plug connector. This pliability can be achieved in various ways.

On the one hand, the sidewall can be made of an elastic and, if necessary, compressible material, in particular a suitable plastic. Alternatively or additionally, the sidewall in question can yield laterally and deflect elastically as required. For this purpose, a hollow design of the sidewall in question is advantageous. Both sidewalls or only one sidewall can be formed according to the hollow design. The two sidewalls can each be designed to be shape retaining in height.

The hollow sidewall can have a cross-section in the area of the connector shank that is open toward the bottom, preferably U-shaped, with an inner cavity. The wide box shape stabilizes the hollow sidewall and the plug connector in its longitudinal direction. On the other hand, the box shape allows an outer wall with advantageous yielding properties to be formed, which act transversely to the longitudinal direction of the connector. This can be achieved, for example, by a thin wall thickness.

On the other hand, one or more hollow sidewalls, in particular their box shape, may each comprise a stiffening in the area of the connector center. This provides additional mechanical stabilization for the plug connector in the area of the connector center. This is advantageous in order to be able to absorb the high bending forces that act on the attached plug connector when handling the spacer or spacer frame and the plug connection. It is furthermore advantageous to reduce the pliability of the corrugated rib contour and/or of the relevant sidewall in the area of the connector center, as well as in the area of the abutment portion of the attached hollow profiles, which is preferably formed there.

In addition, the first aspect of the invention allows the plug connector to be used for several different shape variants, possibly from different profile manufacturers, and for different widths of hollow profiles. This may concern, for example, different profile contour designs (variants) and, if applicable, different widths of hollow profiles. The various options for a pliable design of the corrugated rib contour and/or the sidewall are particularly advantageous in this regard. The pliability or spring deflection can be considerable.

The second aspect of the invention enables increased and improved absorption of height tolerances of the plug connector and/or the hollow profiles. The preferred designs of bottom-side restraining elements as bottom lamellae and edge-side elastic restraining elements as upward protruding detent lugs offer, in their interaction, a particularly high degree of pliability in the height direction of the plug connector and transversely to the main plane of the connector bottom. The deformation paths of the base lamellae and the separate detent lugs can be particularly large and can add up. The claimed plug connector therefore has a particularly high tolerance capacity even at the aforementioned height. It can also be used for several hollow profiles with different internal heights and for different shapes of hollow profiles.

The usability of the claimed plug connector for different hollow profiles is particularly good when the two aspects of the invention are used in combination. The multiple uses of the plug connector offer technical and economic advantages. The number of plug connectors required for different hollow profile formats and the associated storage and administrative expenditures can be reduced. Furthermore, the handling safety of the plug connectors for operating personnel is improved and the susceptibility to errors due to possible operating errors is reduced. Last but not least, the secure hold of the plug connectors in the hollow profiles is also improved.

The third aspect of the invention has various advantages. The differently shaped side walls can have different widths. The reduction in width on the narrow, preferably solid, side wall benefits the width of the hollow interior and the flow cross-section of the granulated desiccant. This is particularly advantageous for narrow plug connectors with a width of <12 mm, for example. Despite the differently shaped side walls, the plug connector can have high mechanical stability, in particular bending strength, and a secure hold in the attached hollow profiles. On the other hand, it is possible to brace the plug connector in the attached hollow profiles, which is also advantageous for mechanical stability and for the hold in the attached hollow profiles.

The claimed plug connector may have the following advantageous features.

With the essentially flat flattening, the rear edge located at the transition to the rib back can be located further out than the other front edge. This is advantageous for the sliding process and also for retaining the plug connector in the hollow profile. The rear edge can dig into the inside of the associated hollow profile wall and can counteract unwanted pulling away of the hollow profile. The division of the rib back into an area steeply sloping down from the rear edge and a subsequent rounded back area is also advantageous for this purpose.

An undercut or recess on the outside of the plug connector below the flattened section is advantageous for exposing the slanted flattened section and enabling it to perform its aforementioned function. A bevel on the relevant side wall above the flattened section also has a positive effect in this regard.

The different angles of inclination of the rib front, the flattening, and the rib back relative to the outside or to the longitudinal direction of the connector, as specified in the subclaims, are also advantageous. The asymmetrical basic shape of the corrugated rib shown in the view from above onto the connector base, with a long rib front sloping gently upward in the outward direction and a short rib back sloping steeply back toward the outside, facilitates the front-end attachment of the hollow profiles and also has advantages for sliding.

The hollow and preferably box-like design of one side wall or both side walls and the inner cavity formed in the process are advantageous for various reasons. On the one hand, the bottom-side and preferably lamellar-type retaining elements can be accommodated in the cavity. They can be firmly connected at one end to the transversal wall of the box shape. The distance between the transversal wall and the connector base can result in a very long length and a corresponding deformability of the bottom-side retaining elements. These can be spaced laterally from the inner wall and outer wall of the hollow box shape. This, in turn, is advantageous in order to enable the aforementioned pliability and deformability of the lateral corrugated rib contour and/or the outer wall.

The inner hollow box shape of one side wall or both side walls can extend over the length of the plug connector and can be closed at the front ends of the connector shanks with a front wall in each case. On the other hand, the aforementioned stiffening in the area of the connector center allows the aforementioned deformation possibilities to be better defined and also limited in favor of maintaining the stability of the outer wall.

The aforementioned stiffening can be designed in various ways for the hollow sidewall or sidewalls. In an advantageous design, it is formed by one or more support blocks in the aforementioned cavity of the sidewall in question. These can be fixedly connected to the transversal wall of the box shape or the sidewall. They can thus already contribute to improving stability. The support blocks can also be connected to the inner wall and/or the outer wall of the respective box shape or the sidewall in question via a support block connection. This can be an alternating connection. The support blocks may be spaced apart from the inner wall and the outer wall, whereby the support block connection may only be arranged on a partial area of the support block surface, in particular at specific points. A plurality of the aforementioned support blocks may be provided. They may also have different axial dimensions.

The plug connector may have at least one center stop in the area of the connector center, which is preferably located on the sidewall(s). In particular, it may be located on the outer side(s) thereof. The center stop limits the insertion length of the hollow profile that is attached. For this purpose, it may comprise wedge shaped stop lugs with rear chamfers and steep abutment faces, which may be arranged on both sides of the connector center at an axial distance. The hollow profiles attached on both sides can meet tightly at an abutment portion formed at the connector center with their preferably flat front sides. This is advantageous for the tightness of the insulating glazing.

In the area of the connector center and the center stop, the sidewall may have a transverse slot that runs transversely to the longitudinal axis of the plug connector. The transverse slot may extend from the outer side of the sidewall to the cavity and, if necessary, open out into it. The outer wall of the hollow box-shaped sidewall may be interrupted or thinned in the slot area. This, together with the support block design, allows the outer wall parts and their respective stop lugs to elastically evade into the cavity when a hollow profile is attached. This is particularly advantageous for sensitive warm edge hollow profiles.

The stiffening can be arranged in the hollow sidewall in question in the area of the center stop. The cavity allows the sidewall area with the center stop to yield elastically when an attached hollow profile passes over. Despite this elasticity, the stiffening stabilizes the plug connector in its central area against high bending moments that can occur when handling spacers with inserted plug connectors.

The connector bottom may have an outer side. This outer side of the bottom is located on the underside of the plug connector. The outer side may have a completely or at least predominantly flat shape in the central area between the sidewalls. The flat shape may extend continuously over the length of the connector. The outer wall of a hollow side wall and the support block or support blocks may extend up to the height of the outer side in the said central area and may have a flat end face here, which may be aligned with the bottom outer side of the base in the middle area. The bottom-side restraining elements or bottom lamellae may protrude beyond the bottom outer side.

The connector bottom may comprise a local recess in the area of one or both front sides. This can also be advantageous for tolerance compensation and size adjustment to different hollow profile formats. The recess may, for example, have a central Y-shape extending from the front side edge of the bottom. The recess may also be designed as a straight slot between the bottom edge and the adjacent sidewall. The recess may also be omitted. If the width tolerance is undersized, the plug connector may deform in the end area and reduce its outer width by bringing the sidewalls closer together. On the one hand, this is advantageous in order to facilitate the attachment of the hollow profiles and, on the other hand, it serves to accommodate the undersize mentioned above. The recess may also be omitted.

One or more axial bottom channels on the preferably flat outer side of the connector bottom can have various advantages. On the one hand, they can facilitate the attachment of the hollow profiles. On the other hand, they can accommodate any rows of perforations on the hollow profile. Such perforations are advantageous for the contact between a granulated desiccant contained in the hollow profiles and the gas located in the interior between the panes of the insulating glazing for drying purposes.

The preferred wedge shape of the edge-side restraining elements has advantages in terms of their deformability. The upward sloping, preferably concave nose front facing the adjacent front side is favorable for forming a defined and relatively thin-walled nose tip. The nose norm is good for high deformability and springy height tolerance absorption of the edge-side restraining elements.

The plug connector can be made from any suitable material. Plastic, e.g. injection-molded, is particularly advantageous. Fiber-reinforced plastic, especially glass fiber-reinforced polyamide, is beneficial. These connector materials are favorable for the desired spring-elastic deformation and tolerance absorption on the one hand, and on the other hand, the embedded fibers provide the necessary stability for a secure fit, retention, and the connecting function of the plug connector in the hollow profiles. Alternatively, bio-based or biodegradable plastics and, for example, cast metal or composite materials are also possible.

The claimed plug connector may be designed as a straight connector or as a corner angle. The center stop may accordingly have different shapes and functions. The aforementioned designs of the plug connector and its connector shank are adapted accordingly.

The plug connector preferably has a hollow interior space extending in the longitudinal direction between the connector bottom and the sidewalls. This allows the desiccant to flow through the plug connector and across the abutment portion of the hollow profiles. The plug connector may have a U-shape that is open at the sides or at the top and continuously extends along the connector length.

In a variation, the plug connector may comprise a local roof wall or bridge that connects the sidewalls transversely in the area of the connector center and may be shorter in length than the plug connector (1). The roof wall or bridge may cover the abutment portion of the attached hollow profiles and may carry a sealant if necessary. The roof wall or bridge may be permanently or detachably connected to the side walls. A bridge may be inserted into the U-shaped plug connector as an additional part. In these cases, the cavity and the desiccant flow remain under the roof plate or bridge. The stability of the connector and the tightness of the plug connection at the abutment portion can be improved.

The plug connector may comprise differently shaped sidewalls. One sidewall may have the aforementioned hollow design with lower restraining elements and, if necessary, with elastic upper restraining elements on the edges. The other sidewall may have a different design. In particular, it may have a smaller width (b′) and, preferably, a smaller height (h′) above the connector bottom than the one sidewall. The other sidewall may also be essentially solid.

The smaller width of the other sidewall is advantageous for narrow hollow profiles and small connector widths of, for example, <12 mm. The interior width can be sufficiently large for the flow of the granulated desiccant. The narrow plug connector can still be held securely and firmly in the attached hollow profiles with reliable retention. The lower and, if necessary, upper resilient retaining elements on one side wall can also be used to compensate for tolerances in height. Tolerance compensation in width can be achieved by the corrugated rib contour preferably present on both side walls.

On the other, in some cases narrower and preferably lower sidewall, the lower and, if applicable, upper springy retaining elements can be omitted. They may be present in another variant.

The upper free edge area of the other sidewall can be flat and preferably without upper restraining elements. A downward sloping bevel can be arranged on the outer edge area of the preferably flat upper wall there. The sidewall height and the bevel can be adapted to the shape of the hollow profiles to be attached in this area, in particular to a possible roof slope at the transition between the sidewall and the profile roof of the hollow profiles.

The other sidewall can be designed to fit the inner contour of the hollow profiles so that it can be braced against the facing inner side of the hollow profiles in the inserted position. This secures the retention and prevents unwanted rotation of the narrow plug connector in the hollow profiles.

On the one hand, the aforementioned adjustment of the reduced side wall height and the beveling can be advantageous for this purpose. On the other hand, an outwardly protruding bottom base on the connector bottom in the area of the connector center can be useful for this purpose.

The bottom base may project outward or downward beyond the aforementioned outer side of the connector bottom in the area of the axially adjacent connector shanks.

The axial length of the bottom base can be limited and significantly shorter than the connector length. It can be limited to the axial length of a stiffening or an axial support block on the one hollow sidewall. It can be limited to the axial extension range of the center stops. The bottom base can thus have a transverse rib-like, raised shape, which is preferably only present in the area of the connector center.

The narrow bottom base is located at the abutment portion of the attached hollow profiles and can support them in the area at and below the other, narrower sidewall. It can extend to the outer edge of this other sidewall and, on the other hand, can end transversely in front of the bottom-side restraining elements of one sidewall. The bottom base can merge into the outer side of the other, narrower sidewall. A corner area may be formed at the transition point, which may be adapted to the corner area of the hollow profiles adjacent to it in the inserted position.

When inserted, the projecting bottom base can distance the connector bottom and its outer side from the base of the hollow profiles. The bottom base can provide a defined contact surface for the hollow profile edges at the abutment portion. This is beneficial for sealing the abutment portion in this area against gas escaping from the interior of the pane and against desiccant escaping from the hollow profiles. In addition, material can be saved in the plug connector.

The projecting bottom base also shortens the free length of the bottom-side restraining elements, in particular bottom lamellae, projecting from the bottom. The height of the bottom base is less than the projecting length of the bottom-side restraining elements, so that these still project beyond the bottom base. This is also advantageous for a defined connector position at the abutment portion and for the aforementioned tightness.

In one variant, the plug connector may comprise one or more local bottom elevations in the area of the connector shank, in particular outside the bottom base, on the aforementioned bottom outer side and/or on the underside of the other, possibly narrower and preferably solid sidewall. Their area is preferably significantly smaller than that of the connector bottom and the underside of the other sidewall. The bottom elevations may, for example, be arranged in the area of the transition between the connector bottom and the other sidewall.

The multiple local bottom elevations can be arranged one after the other in the longitudinal direction of the connector, e.g., in a row or in several parallel rows. The one or more local bottom elevations can extend up to the height of the outer side of the bottom base. They can support the plug connector against the profile bottom of the hollow profiles.

The multiple local, possibly aligned in a row, bottom elevations can, for example, have a wedge shape that rises toward the connector center and be designed as approach ramps. Alternatively or in addition to a row of individual bottom elevations, there can also be a strip-shaped, axially extended bottom elevation that can, for example, form a support rib.

The bottom base can also be omitted in another embodiment, whereby the aforementioned corner area can be formed between the preferably flat bottom outer side of the connector bottom and the other narrower sidewall.

The other, possibly narrower sidewall may have a narrow slit-shaped axial cavity on its underside, which is located in the area of the connector center, in particular of the bottom base that may be located there. The narrow cavity may be open to the outside at the bottom. It may be located in the area of the center stop and its length may be adapted to the axial extension of the center stop. The center stop may have the aforementioned design with stop lugs and a transverse slot.

The claimed plug connection comprises the claimed plug connector and the aforementioned hollow profiles. These can be made of metal, e.g., light metal or stainless steel, and/or plastic. Other materials are also possible. Advantageously, the hollow profiles are designed as warm edge hollow profiles, which have a particularly good heat-insulating effect in insulating glazing.

The warm edge hollow profiles can be manufactured, for example, as so-called hybrid profiles made of plastic and metal. They can also be made of styrene acrylonitrile (SAN for short). This material is particularly advantageous for insulating glazing due to its high strength, UV resistance, chemical resistance, and low moisture absorption. On the other hand, it can have a brittle and sensitive material structure, which is in particular sensitive to pressure, as well as larger tolerances of the interior space in the width and height of the profile shape due to the manufacturing process.

The claimed plug connector is particularly well suited for such warm edge hollow profiles. Its design allows it to accommodate these larger tolerance ranges on the one hand, while ensuring good and secure retention in the hollow profiles on the other, without overloading or damaging the brittle and sensitive hollow profile material.

The hollow profiles may comprise a preferably flat profile bottom, preferably parallel profile walls, and a flat or arched profile roof. The connector bottom of the plug connector may rest against the profile bottom and may cover the front side abutment portion of the hollow profiles. The connector bottom and the profile bottom may face the pane interior of the insulating glazing.

In the plug connection, the plug connector can comprise the aforementioned differently shaped side walls, whereby it can brace itself against the profile bottom and the profile roof in the area of the one hollow sidewall with lower and, if necessary, upper elastic restraining elements. In the area of the other sidewall with its flat upper wall and the bottom base, it can brace itself against the profile bottom and the roof slope of an arched profile roof.

Further advantageous embodiments of the invention are specified in the subclaims.

The invention is illustrated in the drawings in an exemplary and schematic manner. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective top view of the plug connector;

FIG. 2 is a perspective view of the plug connection;

FIG. 3 is another perspective view of the plug connector shown in FIG. 1;

FIG. 4 is a cross-section through the plug connector according to section line IV-IV of FIG. 1;

FIG. 5, FIG. 6, FIG. 7 and FIG. 8 are various views of the plug connector shown in FIG. 1;

FIG. 9 is an enlarged view of detail IX of FIG. 8;

FIG. 10 is a broken and enlarged side view of the plug connector, FIG. 11 is a folded top view of the plug connector from FIG. 10;

FIG. 12 is an enlarged view of detail XII of FIG. 11;

FIG. 13 is a broken and enlarged perspective detail view of a corrugated rib;

FIG. 14 is a broken and enlarged bottom view of the plug connector in the connection area;

FIG. 15 is a perspective longitudinal section of the plug connector according to section line XV-XV of FIG. 6;

FIG. 15a is a longitudinal section of the plug connector along section line XVa-XVa of FIG. 7;

FIG. 16 is a perspective and broken bottom view of the plug connector in the connection area with the stiffening;

FIG. 17 is a cross-section of the plug connector along section line XVII-XVII of FIG. 6;

FIG. 18, FIG. 19 and FIG. 20 are various perspective and folded views of a variant of the plug connector;

FIG. 21, FIG. 22 and FIG. 23 are various perspective and folded views of another variant of the plug connector;

FIG. 24, FIG. 25, FIG. 26 and FIG. 27 are various perspective and folded views, as well as a detailed view of another variant of the plug connector;

FIG. 28, FIG. 29 and FIG. 30 are various, partially sectional front views of the plug connector from FIGS. 24 to 27;

FIG. 31 and FIG. 32 are a perspective view and a front view of a plug connection of the plug connector from FIGS. 24 to 30 with a hollow profile; and

FIG. 33, FIG. 34, FIG. 35, FIG. 36, FIG. 37 and FIG. 38 are various views of a variant of the plug connector shown in FIGS. 24 to 32.

### DESCRIPTION OF PREFERRED EMBODIMENTS

Referring to the drawings, the invention relates to a plug connector (1) for hollow profiles (2) of a spacer (3) of insulating glazing (4). The invention also relates to a plug connection (45) consisting of a plug connector (1) and a hollow profile (2).

The hollow profiles (2) can be profile sections of the spacer (3). A frame-shaped spacer (3) can be bent from a single hollow profile in one piece and connected at the profile ends with the inserted plug connector (1). A frame-shaped spacer (3) can also be formed from several individual straight and/or curved hollow profiles (2) with plug connectors (1) at the profile connection points.

The plug connector (1) can be designed in different ways.

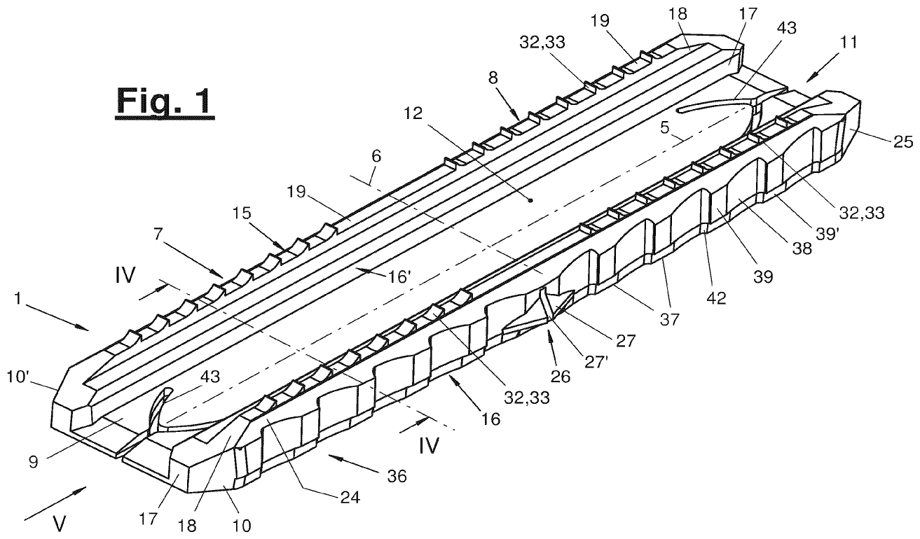

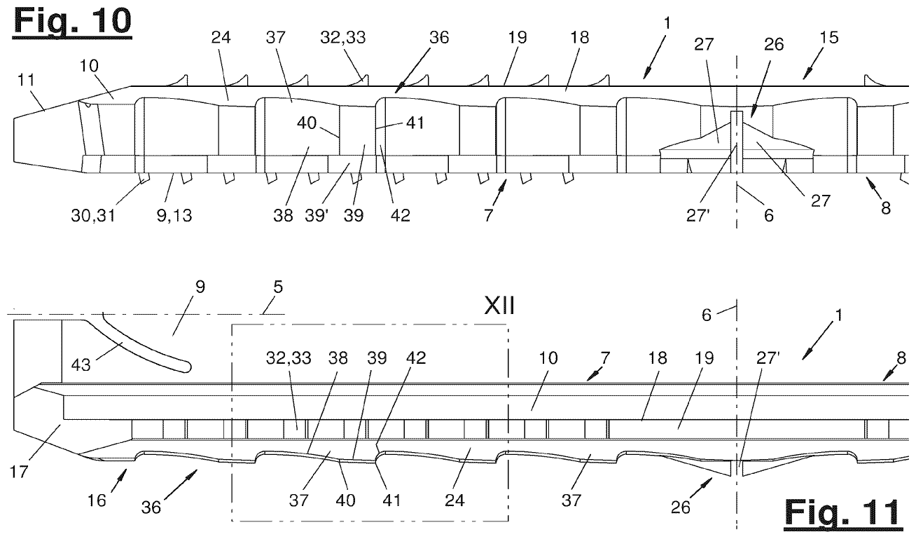

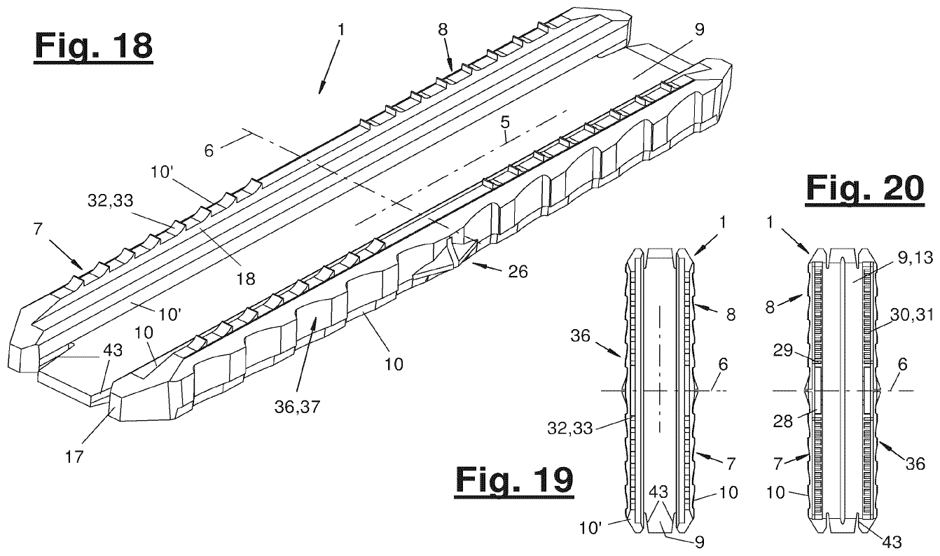

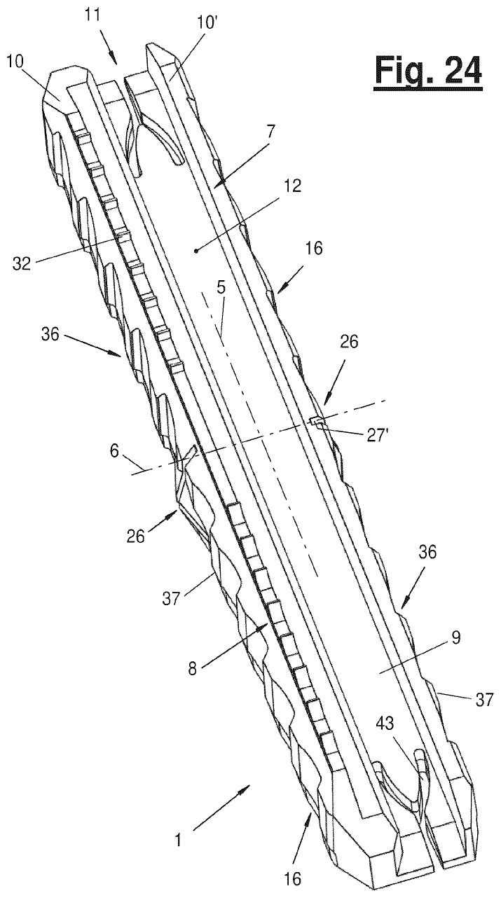

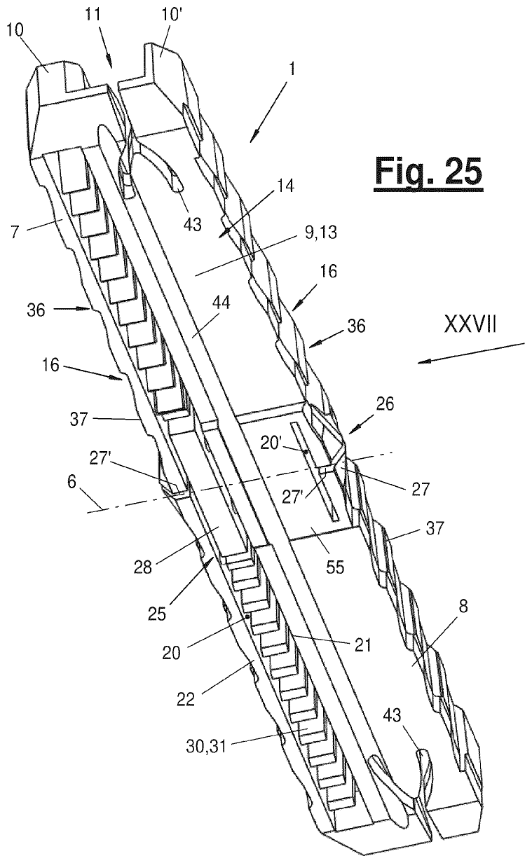

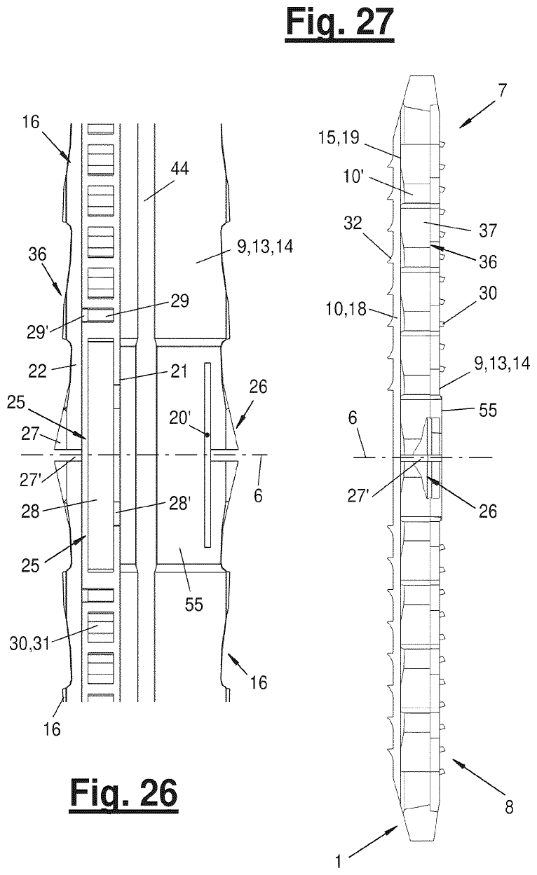

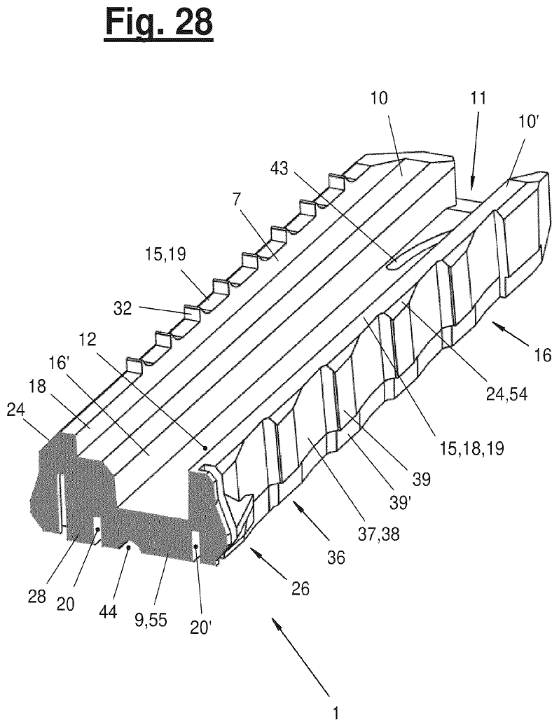

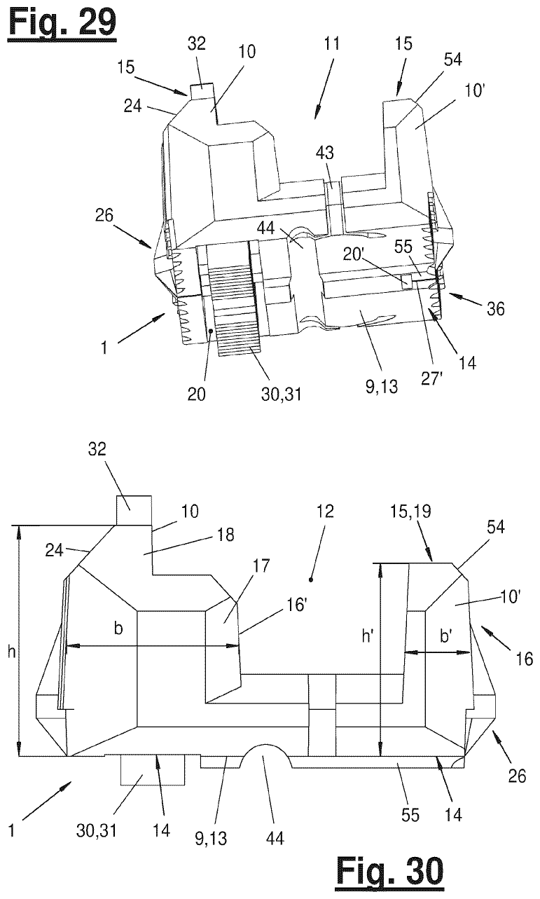

A first variant is shown in FIGS. 1 and 3 to 17. FIGS. 18 to 20 and FIGS. 21 to 23 each show a different variant. The variants of the plug connector (1) shown may differ in the existence and design of a recess (43) on the connector bottom (9) and may otherwise have the same design. FIGS. 24 to 38 show two further variants of the plug connector (1).

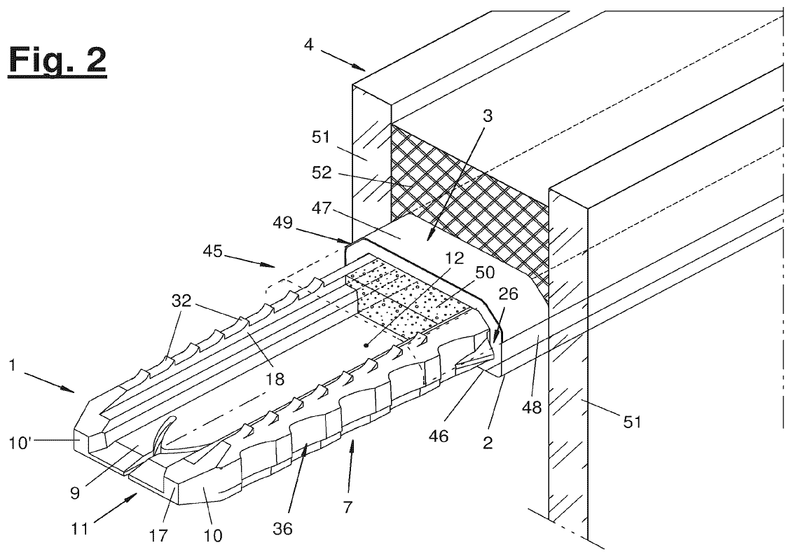

FIG. 2 shows a plug connection (45) between a plug connector (1) and a hollow profile (2) attached on one side to insulating glazing (4). The insulating glazing (4) shown in broken view comprises, for example, two parallel panes (51) between which the hollow profile (2) or the spacer (3) formed by it is arranged and, if necessary, covered on the outer side by a seal (52) made of butyl or similar material. In the plug connection (45), two hollow profiles (2) attached to the plug connector (1) in its longitudinal direction (5) meet at an abutment portion (49) on their front sides. The second hollow profile attached is indicated in FIG. 2 with a dashed outline.

The spacer (3) or spacer frame can be arranged around the perimeter between the panes (51) and encloses an interior space between the panes (51), which can be filled with a gas. In a modification of FIG. 2, the insulating glazing (4) may comprise more than two panes (51) and two or more plug connectors (45). The panes (51) may be made of glass or another preferably translucent material.

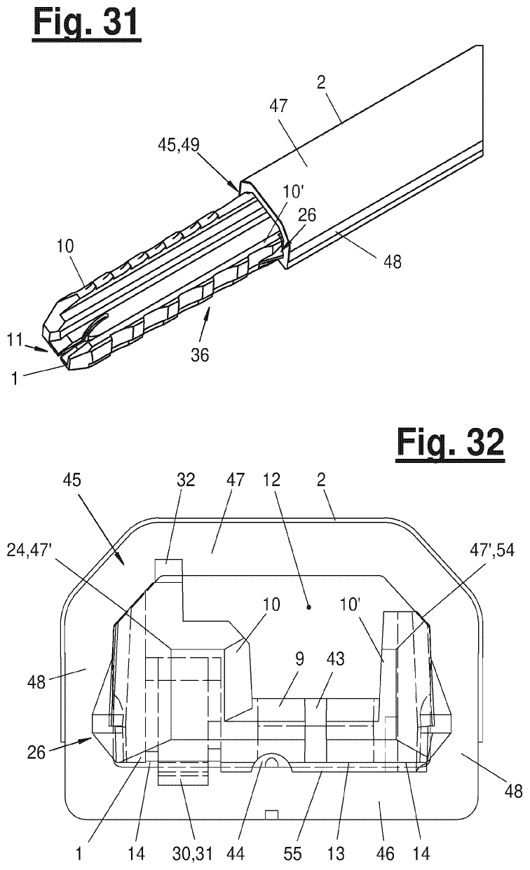

FIGS. 31, 32, and 35 each show a plug connection (45) with one of the other variants of the plug connector (1) from FIGS. 24 to 30 and 33 to 38.

According to FIG. 2, the hollow profiles (2) each have a profile bottom (46) facing the interior of the pane, an opposite profile roof (47), and lateral profile walls (48). The hollow profiles can be designed, for example, as warm edge hollow profiles and have a very low heat transfer coefficient. The hollow profiles (2) can be made of any suitable material, in particular metal and/or plastic. The hollow profiles (2) can be filled in their hollow interior space with a flowable, e.g., granulated, desiccant (50). The desiccant (50) can be in contact to the gas in the interior space of the pane via possible rows of perforations in the profile bottom (46) and dehumidify it.

As FIGS. 1 and 2 illustrate, the plug connector (1) may have, at least in some areas, a substantially U-shaped cross-section with preferably open front sides (11) and an internal hollow interior space (12). The U-shaped plug connector (1) may have a connector bottom (9) on its underside and sidewalls (10, 10′) adjoining its longitudinal edges and protruding upward transversely to the main plane of the connector bottom (9). The sidewalls (10, 10′) are of the same design in the embodiments shown in FIGS. 1 to 23.

The sidewalls (10, 10′) are preferably hollow and each have an outer side (16) and an opposite inner side (16′) facing the interior space (12). As FIG. 2 illustrates, the desiccant (50) can flow through the inserted plug connector (1). In the inserted position or in the plug connection (45) shown, the connector bottom (9) preferably abuts against the profile bottom (46) and covers the front side abutment portion (49) of the hollow profiles (2).

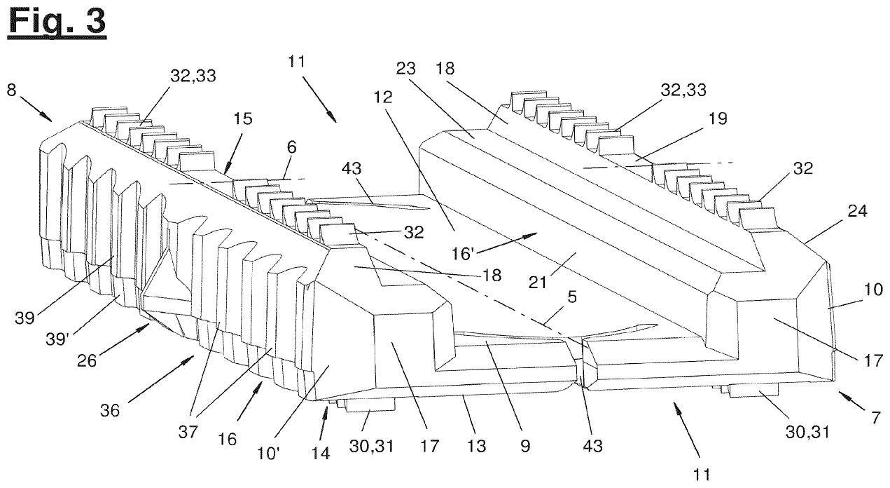

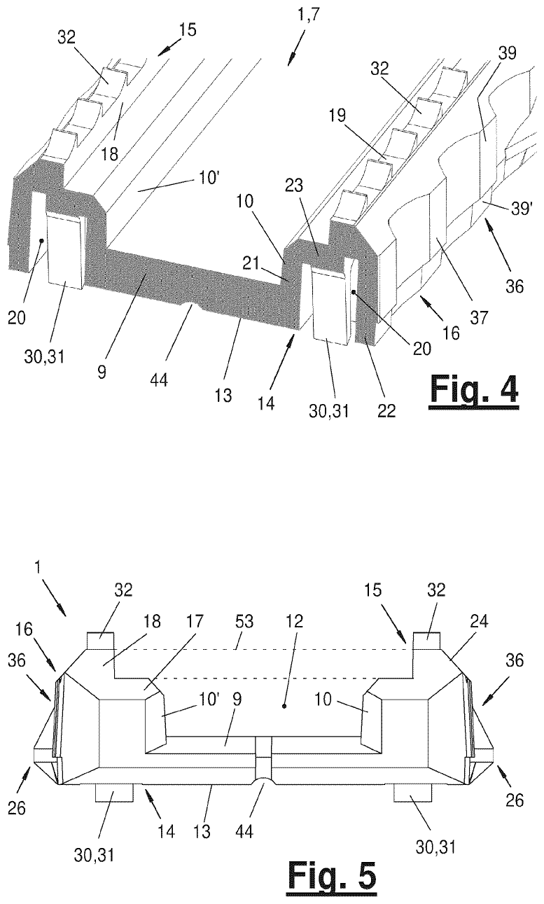

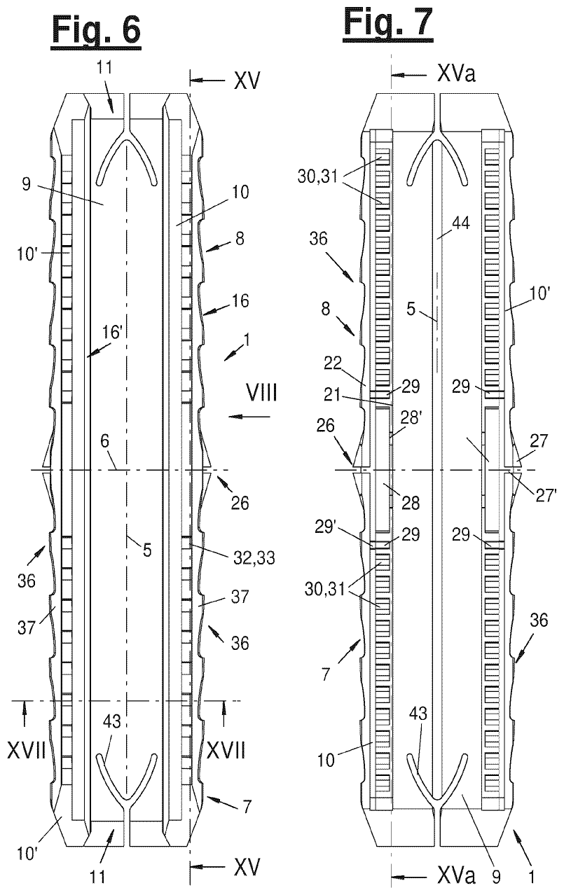

FIGS. 1 and 3 show the plug connector (1) of the first variant in various perspective views. FIGS. 5 to 8 show the plug connector (1) in various folded views. Further details of the plug connector (1) are shown in FIGS. 4 and 9 to 17.

In the embodiments shown, the plug connector (1) is designed as a straight plug connector. It has the aforementioned, essentially U-shaped cross-sectional shape. The plug connector (1) has a longitudinal direction (5) and a connector center (6). This is the center as seen in the longitudinal direction (5). Connector shanks (7, 8) extend from both sides of the connector center (6) in the longitudinal direction (5). In the straight connector shown, the connector shanks (7, 8) are aligned.

The plug connector (1) has a preferably solid connector bottom (9) on its underside and the aforementioned hollow sidewalls (10, 10′) adjoining its longitudinal edges. The connector bottom (9) has an outer side (13) that faces away from the interior space (12) and is essentially flat in the area between the sidewalls (10, 10′) or has a flat surface.

The side walls (10, 10′) may, for example, have a stepped outer cross-sectional shape formed by a wide and preferably hollow sidewall base (17) in the bottom area and a narrow sidewall bar (18). The sidewall bar (18) protrudes upward from the top of the sidewall base (17) in a direction transverse to the main plane of the connector bottom (9). Together with its upper wall (19), it forms the upper free edge area (15) of the sidewall (10, 10′).

The sidewalls (10, 10′) each have springy restraining elements (30) projecting downward on their underside (14), which also project beyond a lower bottom outer side (13) of the connector bottom (9). The restraining elements (30) can be designed in different ways. Preferably, they are designed as thin-walled and plate-shaped bottom lamellae (31) which are arranged in the inner cavity (20) of the respective sidewall (10, 10′) and project downwards from the cavity (20).

The underside of the plug connector may have a flat and essentially level shape. The outer side (13) of the connector bottom (9) may form a flush transition into the underside (14) of the double-sided sidewalls (10, 10′) as shown in the front view of FIG. 5.

At least one sidewall (10, 10′) of the plug connector (1) comprises a laterally projecting corrugated rib contour (36) on its outer side (16), with each rib crest being flattened at an angle. The rib contour (36) runs in the longitudinal direction (5). The aforementioned lateral projection is directed outward and along the main plane of the connector bottom (9). In the embodiments shown, both sidewalls (10, 10′) comprise the aforementioned corrugated rib contour (36) on their respective outer sides (16). The longitudinally extending rib contour (36) may be interrupted in the area of the connector center (6). A center stop (26), which will be explained below, may be arranged here.

The sidewalls (10, 10′) each comprise additional edge-side elastic restraining elements (32) on their upper free edge area (15) facing away from the connector bottom (9). The restraining elements (32) preferably project from the edge area (15) in a direction transverse to the main plane of the connector bottom (9).

In the embodiments shown, the plug connector (1) comprises both the corrugated rib contour (36) and the edge-side elastic restraining elements (32). In another embodiment not shown, the upper edge-side elastic restraining elements (32) may be omitted. In a further variant, it is possible for the plug connector to have the aforementioned edge-side elastic restraining elements (32), whereby the one or more corrugated rib contours (36) are omitted and the outer sides (16) of the sidewalls (10, 10′) are designed in a different manner.

In the embodiments shown, the corrugated rib contour (36) is formed by several corrugated ribs (37) arranged one behind the other in the longitudinal direction (5).

The corrugated ribs (37) project laterally from the outer side (16) and each have a slanted flattening (39) at the rib crest. The corrugated ribs (37) are preferably molded onto the respective sidewall (10, 10′). They may also be attached there in other ways. The corrugated ribs (37) are each aligned differently on the connector shanks (7, 8).

The corrugated ribs (37) abut against each other in the longitudinal direction (5). The corrugated rib contour (36) preferably extends over the entire length of the connector shanks (7, 8) and preferably has the aforementioned interruption in the area of the connector center (6). As the side view of FIG. 8 and the various other views illustrate, the slanted flattening (39) of a corrugated rib (37) can be arranged between a rib front (38) and a rib ridge (42). The rib front (38) faces the adjacent front side (11) of the plug connector (11). The rib ridge (42) faces the connector center (6). The corrugated ribs (37) have correspondingly differently oriented formations on the connector shanks (7, 8).

The flattening (39) preferably has a substantially flat shape. The flattening has an upright edge (40) extending transversely to the connector bottom (9) at the transition to the rib front (38) and a further upright edge (41) at the transition to the rib ridge (42). The rear edge (41) located toward the connector center (6) may have a sharper edge profile than the front edge (40) facing the front side (11).

The slanted flattening (39) rises diagonally outward toward the connector center (6). The rear edge (41) is further outward than the front edge (40) in relation to the outer side (16). The corrugated ribs (37) are each divided into three differently shaped areas by the rib front (38), the flattening (39), and the rib ridge (42). In a modified embodiment, further differently shaped areas may be added.

The corrugated ribs (37) each have an asymmetrical shape when viewed from above or from the top down to the connector bottom (9). Herein, for example, the rib front (38) is longer than the flattening (39), and the flattening (39) is in turn longer than the connector back (42). The rib front (38), the flattening (39), and the rib ridge (42) also have different shapes. The front (38) rises diagonally outward from its base point on the outer side (16). It can have a straight or concave shape when viewed from above. The rib front (38) transitions into the flattening (39) via the front edge (40). The rib ridge (42) connects to its rear edge (41), which again recedes toward the outer side (16) and can merge back into the next rib front (38) of the next corrugated rib (37) at the end.

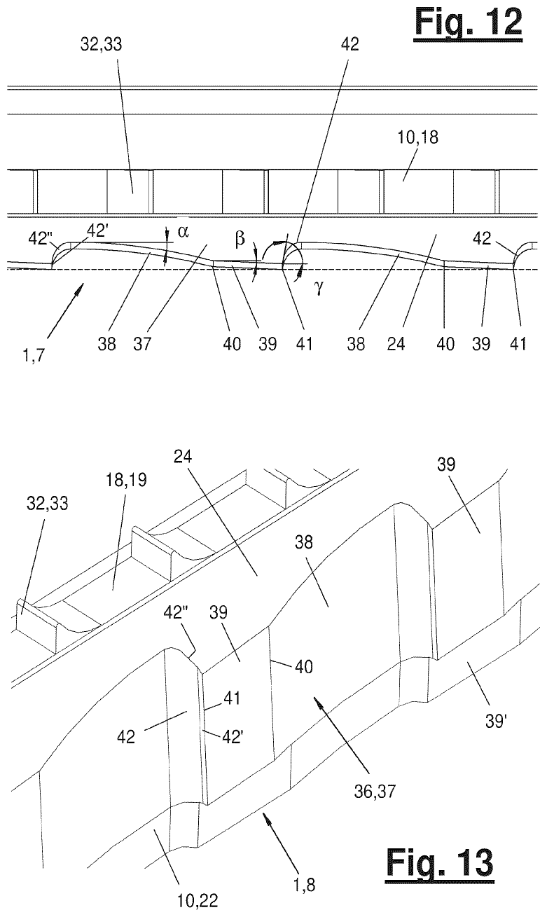

The rib ridge (42) has a steeply sloping back portion (42′) with a preferably pronounced rear edge (41) and a rounded back portion (42″) adjoining it. The steep back section (42′) and the flattening (39) can form an angle of approximately 90° with each other. FIGS. 11 and 12 show this design with reference to the connector shank (7) as an example. FIG. 13 shows another perspective view looking from the connector center (6) to the other connector shank (8).

The rib front (38), the flattening (39), and the rib ridge (42) of the corrugated rib have different angles of inclination relative to the outer side (16). This refers to the main plane of the outer side (16) or its extension in the longitudinal direction (5).

The rib front (38) rises from the outer side (16) at a shallow angle (α), with the subsequent flattening (39) rising less steeply at an angle (B). The rib ridge (42) slopes steeply down to the outer side (16) at an angle (γ). The angle (CC) is greater than the angle (β) and smaller than the angle (γ). The angles are, for example, approximately 10° for angle (α), approximately 5° for angle (β), and approximately 280° for angle (γ). This refers to the longitudinal direction (5) in each case and is shown in detail in FIG. 12 in a top view.

The sidewall (10, 10′) has an undercut (39′) on the outer side (16) in the area of the rib contour (36) below one or more flattenings (39). The undercut forms a recess or step relative to the flattening (39). FIGS. 4 and 13 illustrate this design in perspective.

The sidewall (10, 10′) also has a bevel (24) on the outer side (16) above the selected rib contour (36), which slopes down toward the rib contour (36). The bevel (24) can, for example, extend from the upper wall (19) of the relevant sidewall bar (18).

As illustrated by the top views in FIGS. 11 and 12 and the front view in FIG. 5 according to arrow V in FIG. 1, the rib front (38), the flattening (39) and the rib ridge (42) of the corrugated ribs (37) each have an slanted inclination, with their lower edges being located further out than their upper edges.

As FIGS. 13 to 17 illustrate, the hollow sidewalls (10, 10′) in the area of the connector shanks (7, 8) each have a cross-sectional box shape that is open toward the underside (14) and preferably U-shaped with the aforementioned inner cavity (20). The hollow box shape is closed at the respective front side (11) of the plug connector (1) by a front wall. The hollow box shape of the side walls (10, 10′) can extend, for example, over the entire length of the connector. It can be stiffened in the area of the connector center (6).

As illustrated in particular by the cross-section in FIG. 17, the hollow box shape of the side walls is formed by an inner wall (21), an outer wall (22) spaced apart from and preferably parallel to the inner wall (21), and an upper connecting transversal wall (23). The corrugated rib contour (36) is arranged on the outer side of the outer wall (22).

The outer wall (22) with the corrugated rib contour (36) can have a spring elastic design. The outer wall (22) is, for example, relatively thin-walled and can yield when a hollow profile (2) is attached and when pressure is applied from the outside, and can elastically deflect toward the hollow interior space (12). The inner wall (21) connects to the connector bottom (9). It may have a greater wall thickness than the outer wall (22). It may stabilize the plug connector (1) in the transverse direction, in particular in combination with the preferably molded connector bottom (9). The transversal wall (23) connecting the two walls (21, 22) is spaced apart from the connector bottom (9). It forms the upper side of the widened sidewall base (17). The inner and outer walls (21, 22) form the inner and outer side walls of the base.

As FIGS. 7 and 8 and 14 to 17 illustrate, the bottom-side restraining elements (30) are arranged in the cavity (20) of the sidewalls (10, 10′). They are lined up one behind the other with a mutual axial distance in the longitudinal direction (5). The bottom-side restraining elements (30) are preferably designed as springy bottom lamellae (31). They may have a blade shape at the free end of the lamellae located outside the sidewall (10, 10′). The bottom-side restraining elements (30) are each firmly connected to the transversal wall (23) at their upper end region and are preferably molded. The bottom-side restraining elements (30) are also spaced apart from the inner wall (21) and the outer wall (22). This allows them to move freely in the cavity (20).

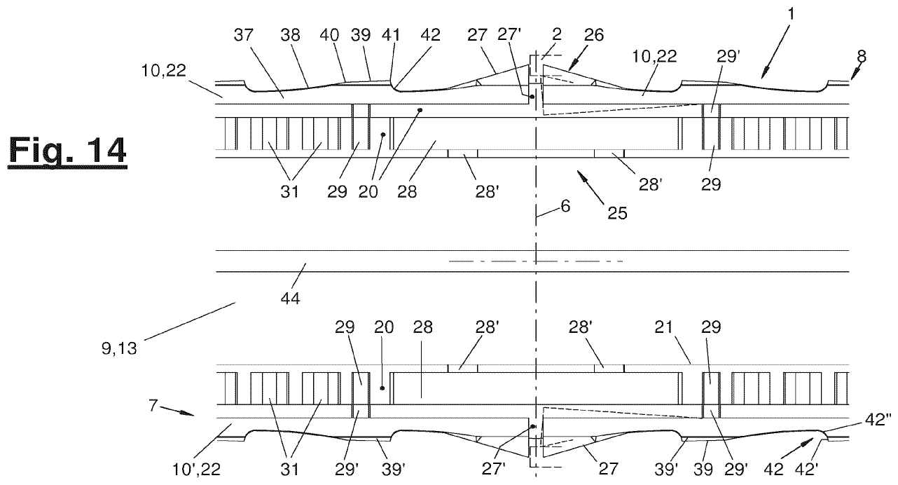

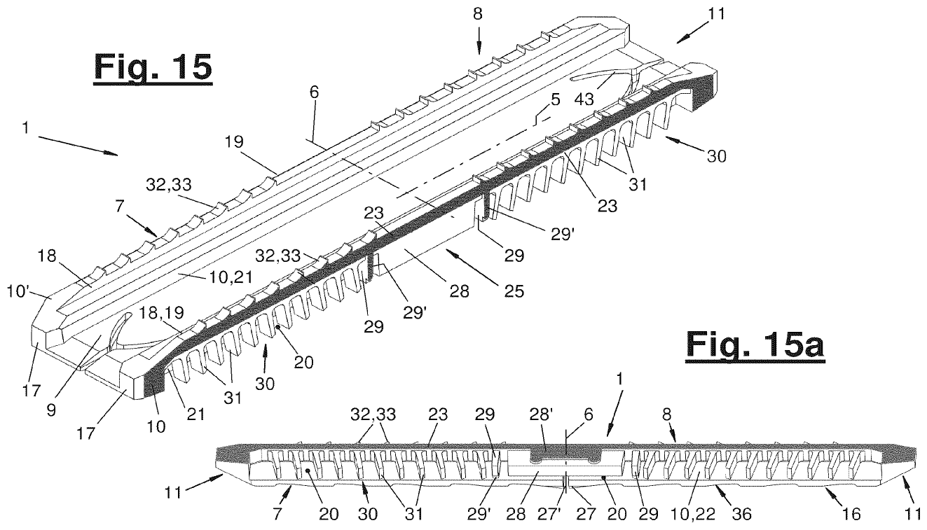

The hollow sidewalls (10, 10′) and their box shape each have a stiffening (25) in the area of the connector center (6). As shown in the bottom views of FIG. 14 16 and the longitudinal sections of FIGS. 15 and 15a, the stiffening (25) is formed, for example, by several support blocks (28, 29) which are arranged on the left and right sides of the connector in the cavity (20) in the area of the connector center (6). In this case, a long support block (28) extending in the longitudinal direction (5) is arranged at the connector center (6), and a short support block (29) is respectively arranged at a distance from each of its axial ends. The long support block (28) extends on both sides into the connector shanks (7, 8). The preferably flat outer side or underside of the support blocks (28, 29) can extend to the bottom outer side (13) and can be flush with it.

The support blocks (28, 29) are each firmly connected to the transversal wall (23). They are also alternately firmly connected to the inner wall (21) and the outer wall (22) of the respective sidewall (10, 10′) via a support block connection (28′, 29′), e.g., by molding. The support block connections (28′, 29′) are preferably only present on a partial area of the respective support block surface. These can be molded support block connections.

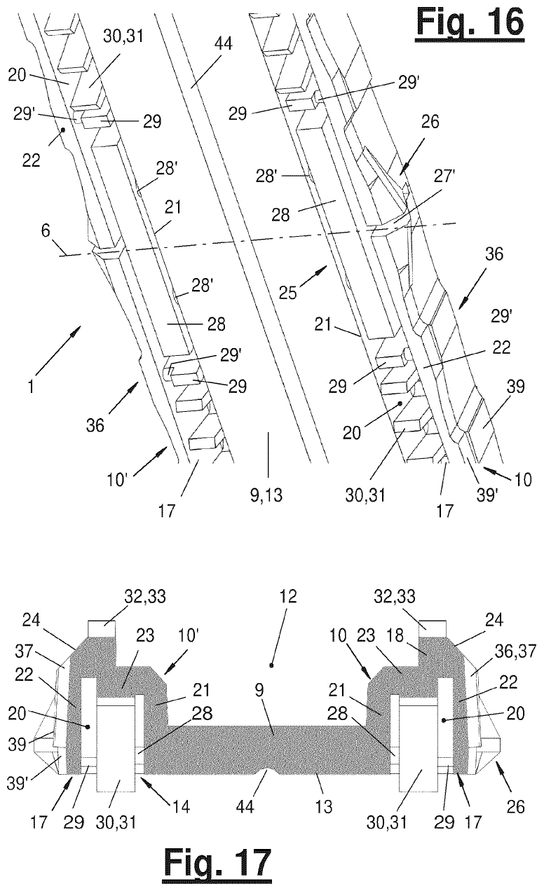

According to the bottom views of FIGS. 14 and 16 and the longitudinal section of FIG. 15a, there is a profiled support block connection (28′) between the long support block (28) and the inner wall (21). The long support block (28) is spaced apart from the outer wall (22). According to the longitudinal section of FIG. 15a, the short support blocks (29) are each connected to the outer wall (22) via a support block connection (29′) and spaced apart from the inner wall (21).

The plug connector (1) has at least one center stop (26) in the area of the connector center (6). This is preferably arranged on the sidewalls (10, 10′) and on their outer sides (16). In the embodiments shown, the center stop (26) comprises two stop lugs (27) in wedge shape that are elastic or otherwise flexible, which are arranged opposite each other at an axial distance to the connector center (6). The wedge shape of the stop lugs (27) rises diagonally from the direction of the respective adjacent front side (11) towards the connector center (7) and then drops steeply across the longitudinal axis (5). This forms an approach ramp and a steep lug front that acts as an abutment surface.

As FIGS. 7, 8, and 10 illustrate, the sidewalls (10, 10′) comprise a transverse slot (27′) extending transversely to the longitudinal axis (5) at the connector center (6) and between the stop lugs (27), which extends from the outer side (16) to the cavity (20) and preferably opens into it. The transverse slot (27′) extends downwards to the outer side (13) of the connector bottom (9) and is open at the bottom. The transverse slot (27′) extends upward only over part of the sidewall height. It can extend, for example, to the transversal wall (23) of the cavity. The outer wall (22) of the box shape can be interrupted or weakened by the transverse slot (27′). The weakened and interrupted outer wall areas can thus elastically evade when a hollow profile (2) is pushed onto the cavity (20).

The outer wall areas can also evade elastically toward the longitudinal support box (28), whereby they are supported at their base by the transversal support boxes (29) and support block connections (29′). FIG. 14 illustrates in dotted lines the deformation and evasion possibilities for a hollow profile (2) pushed unto the connector shank (8). The hollow profile (2) can then abut against the stop lugs (27) of the other connector shank (7) located beyond the connector center (6).

As FIG. 2 of the plug connector (45) illustrates, the first hollow profile (2) pushed on, for example, to the connector shank (8) passes over the associated and evasive stop lugs (27), whereby the steep lug fronts of the other stop lugs (27) arranged beyond the connector center (6) then form a stop for the front side of the hollow profile (2) in question. The second hollow profile (2), which is then pushed onto the other connector shank (7), abuts against the front side of the first hollow profile (2) squarely after passing over its stop lugs (27), whereby the abutment portion (49) is formed here.

The plug connector (1) has entry bevels at the ends of the connector bottom (9) and the sidewalls (10, 10′) on each of its front sides (11). FIGS. 1, 3, 6, and 7 illustrate this embodiment. The entry bevels facilitate the pushing on of the hollow profiles (2).

The plug connectors (1) of the first and second variants of FIGS. 1 to 23 each have a recess (43) on the front sides (11) and on the connector bottom (9). In the first variant of FIGS. 1 to 17, a single recess (43) is arranged on each of the front sides (11), which has a Y-shape. The recess (43) is designed as a slot-like opening in the connector bottom (9). It starts at the base of the “Y” from the edge of the bottom and widens towards the connector center (6).

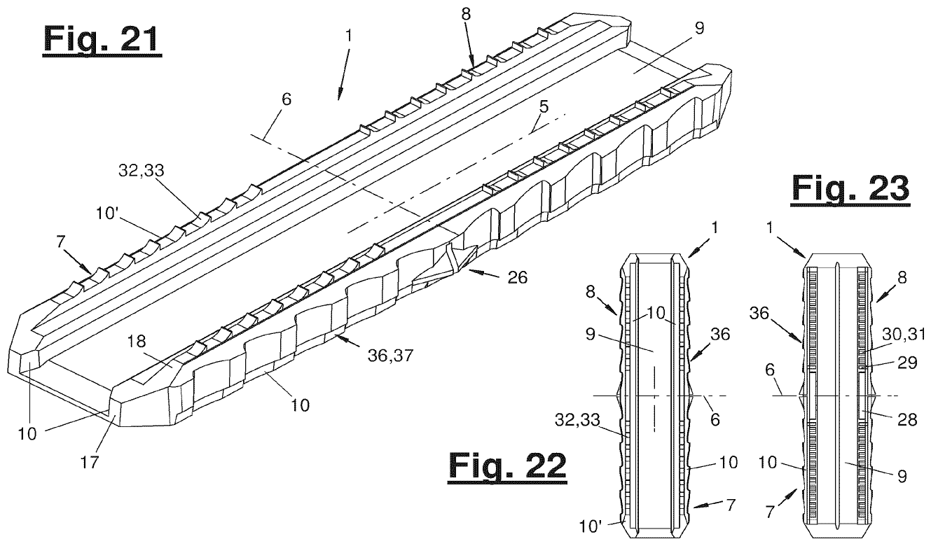

In the second variant of FIGS. 18 to 20, multiple recesses (43) are arranged on the front sides. It is formed by a slot extending in the longitudinal direction (5) between the connector bottom (9) and the adjacent sidewall (10, 10′). The slot-like openings in both variants allow the plug connector (1) to yield and deform laterally at the front side when a hollow profile (1) is pushed on. In the third variant shown in FIGS. 21 to 23, there is no recess (43). The connector bottom (9) is solid throughout the longitudinal direction (5).

The connector bottom (9) may have one or more longitudinal bottom channels (44) on its preferably flat bottom outer side (13), as shown in FIGS. 4 and 5. These may each accommodate a row of perforations on the profile bottom (6) and be positioned accordingly.

In the embodiments shown, the edge-side restraining elements (32) are arranged on the preferably flat upper wall (19) of the respective sidewall bar (18) of the base-like stepped sidewalls (10, 10′). They are arranged in a row one after another at a distance from each other in the longitudinal direction (5). The restraining elements (32) are absent in the area of the connector center (6).

The restraining elements (32) described below and arranged at the upper free edge area (15) of the sidewalls (10, 10′) can be used with the base-like sidewalls (10, 10′) shown and also with other sidewall shapes that differ from these, e.g., plate-like sidewalls.

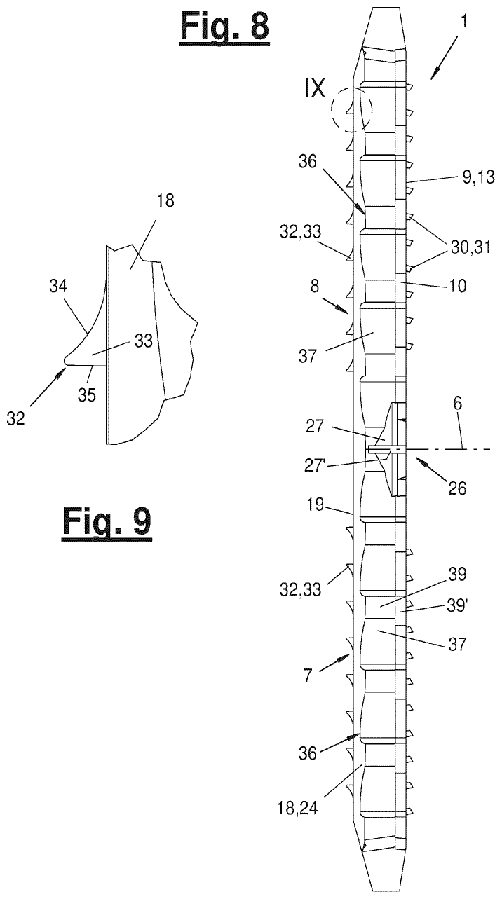

The edge side restraining elements (32) are each designed as wedge shaped and spring elastic edge lugs (33). FIGS. 8 and 9 illustrate their design.

The edge lugs (33) each comprise a lug front (34) facing the adjacent front side (11) of the plug connector (1), which rises at an angle from the edge area (15) or the upper wall (19) toward the upper lug tip. The edge lugs (33) also have a lug ridge (35) pointing towards the connector center (6), which slopes down steeply from the lug tip to the free edge area (15) or upper wall (19). The lug front (34) preferably has a concave curved shape. The lug ridge (35) preferably slopes down vertically toward the area (15) or the upper wall (19).

In the embodiments shown, the plug connector (1) is made of a fiber-reinforced plastic, in particular a glass fiber-reinforced polyamide, and is preferably designed as an injection-molded part. The connector material can be compressed to a small extent under pressure. It can also be deformed in a spring elastic way, e.g., at the bottom side and edge side restraining elements (30, 32). In addition, the outer wall (22) of the hollow side walls (10, 10′) can spring elastically deform.

FIGS. 24 to 38 show another embodiment of the plug connector (1) and the plug connection (45) in two variants. In these, the sidewalls (10, 10′) of the plug connector (1) are each designed differently. One hollow sidewall (1) is designed in accordance with the embodiments described above of FIGS. 1 to 23. The other sidewall (10′), on the other hand, has a different design.

The corrugated rib contour (36) described above and the corrugated ribs (37) together with the bevel (24) are preferably present on both side walls (10, 10′). They can be designed to be symmetrical about the longitudinal axis (5). FIGS. 26 and 27 illustrate this uniform design of the selected rib contour (36) in a broken and enlarged bottom view and in a folded side view. The described above recesses (43) and the bottom channel(s) (44) can be arranged on the connector bottom (9).

The other sidewall (10′) is essentially solid. In addition, the lower and upper springy restraining elements (30, 32′) described above are missing on this other sidewall (10′).

As shown in FIG. 30 in a front view, the other sidewall (10′), which is solidly formed in the area of the connector shanks (7, 8), has a width (b′) that is less than the width (b) of the one hollow side wall (10). Furthermore, the height (h′) of the other sidewall (10′) above the outer side (13) of the connector bottom (9) is less than the height (h) of the one hollow sidewall (10). This can also be seen in the side view of FIG. 27. The upper reference point for the height (h′, h) is the upper wall (19) at the respective free edge area (15) of the sidewalls (10, 10′).

As FIGS. 24 and 28 illustrate in various perspective views, the other sidewall (10′) has a flat upper wall (19) at its free upper edge area (15). This flat shape can extend across the entire length of the sidewall. As shown in FIG. 29 in a perspective front view and FIG. 30 in a front view, there may be a bevel (54) sloping down toward the outer side (16) at the outer edge of the upper wall (19). The bevel (54) is adapted to a roof slope (47′) of the hollow profiles (2).

In the variant shown in FIGS. 24 to 32, the plug connector (1) has a base (55) projecting outward on the outer side (13) of the connector bottom (9) in the area of the connector center (6). This extends in the longitudinal direction (5) on both sides beyond the connector center (6). In the transverse direction, the base (55) extends to the outer side (16) of the other sidewall (10′). In the opposite direction, the base socket (55) ends in front of the cavity (20) and, if applicable, in front of the bottom side restraining elements (30) of one hollow sidewall (10). The bottom channel (44) extending over the connector length is also present in the area of the bottom base (55).

The bottom base (55) is located only in the area of the connector center (6). It has an axial length that is significantly shorter than the connector length. As FIGS. 25 and 26 illustrate, the position and axial length of the bottom base (55) can correspond to the position and length of the stiffening (25), in particular of the axial support block (28). The bottom base (55) is also located in the area of the center stops (26) and can correspond to their axial extension in length.

The height of the outwardly projecting bottom base (55) is smaller than the free length of the lower springy restraining elements (30) projecting beyond the connector bottom (9) on the outer side. The stiffening (25), in particular one of an axial support block (28), can also project outward beyond the bottom outer side (13) in the variants shown in FIGS. 24 to 38 and can extend up to the height of the bottom base (55). FIG. 28 illustrates this design.

When inserted, the plug connector (1) rests with its bottom base (55) and, if applicable, the support block (28) on the profile bottom (46) in the area of the abutment portion (49). Its outer side corner area can be adapted to the adjacent corner area between the profile bottom (46) and the side profile wall (48). It can rest against this area and, if necessary, fit snugly. The corner area can be designed as a pronounced and preferably sharp-edged corner.

FIGS. 31 and 32 show a perspective view and a sectional front view of the plug connection (45) and the insertion position of the plug connector (1) in one of the hollow profiles (2). The plug connector (1) braces itself elastically against the profile bottom (46) and the e.g. arched profile roof (47) with its lower and upper springy restraining elements (30, 32) on one hollow sidewall (10). The upper restraining elements (32) engage with the upper and bottom-parallel area of the profile roof (47). The bevel (24) of one sidewall (10) can be adapted to the roof slope (47′).

The plug connector (1) can be braced against the inner side of the attached hollow profiles (2) facing the plug connector (1) with the other sidewall (10′). The shortened side wall height (h') and the bevel (54) can be adapted to the height of the side profile wall (48) and the transition point, as well as the design of the roof slope (47′) at that point. FIG. 32 shows this bracing position in a front view.

The other sidewall (10′) can be essentially solid. On its underside (14), in the connector shank areas outside the bottom base (55), it can have a flat outer side or outer surface which, for example, merges flush with the equally essentially flat outer side (13) of the connector bottom (9). FIG. 29 illustrates this design.

As FIGS. 25, 26, 28, and 29 illustrate, the other sidewall (10′) may have a narrow slit-shaped axial cavity (20′) on its underside (14) in the area of the connector center (6) and the bottom base (55). This cavity is open to the outside on the bottom side. The cavity (20′) is arranged in the area of the adjacent center stop (26) of the other sidewall (10′), as shown in FIG. 26. The axial length of the cavity corresponds to the axial extension of the center stop (26), which is preferably designed in the prescribed manner with stop lugs. The other sidewall (10′) is provided with the prescribed transverse slot (27′) at the connector center (6), which also extends to the cavity (20′) in the other sidewall (10′). The center stop (26) can thus elastically evade into the cavity (20′) when a hollow profile (2) is pushed on.

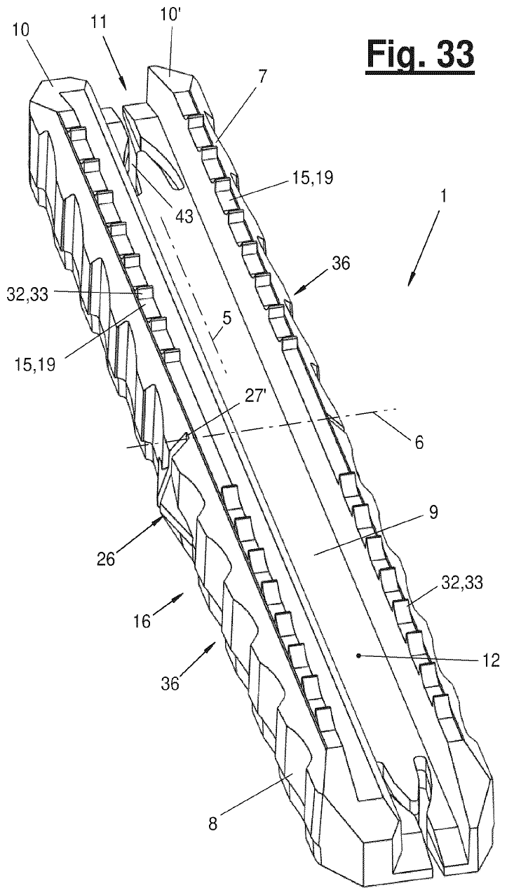

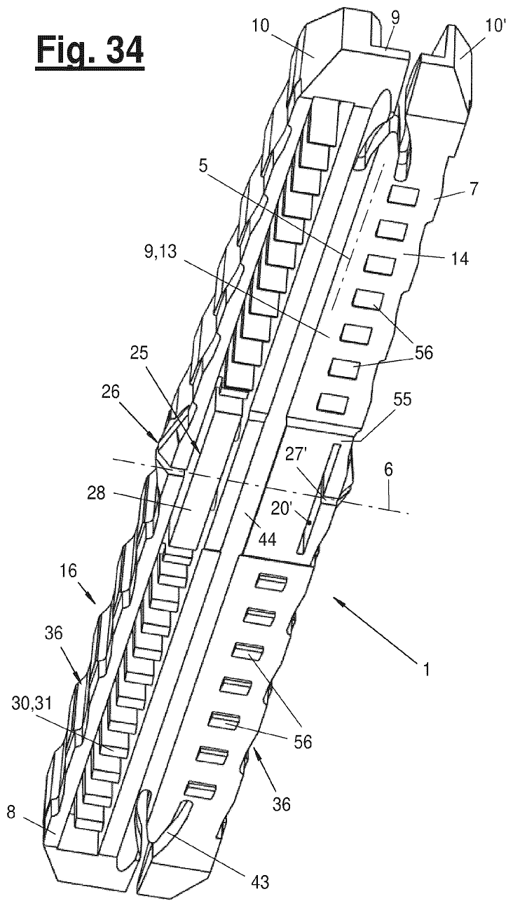

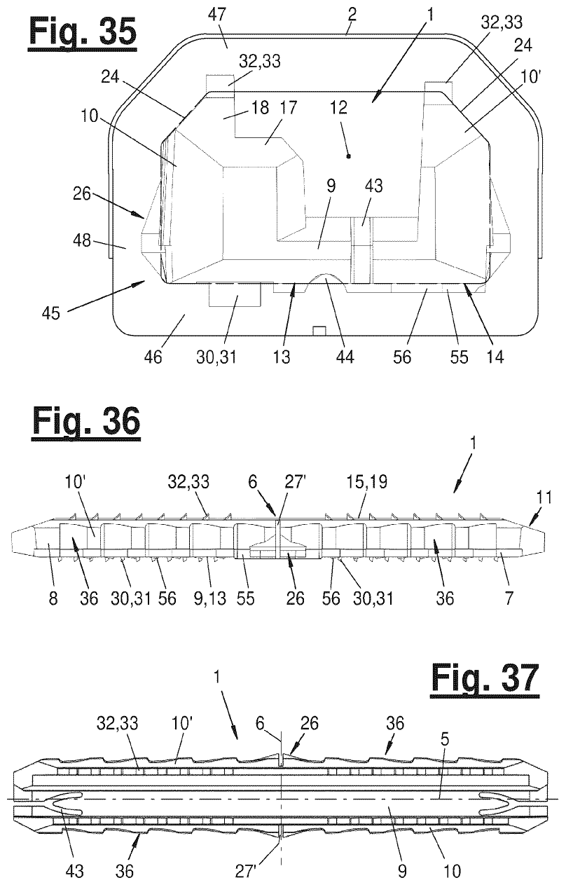

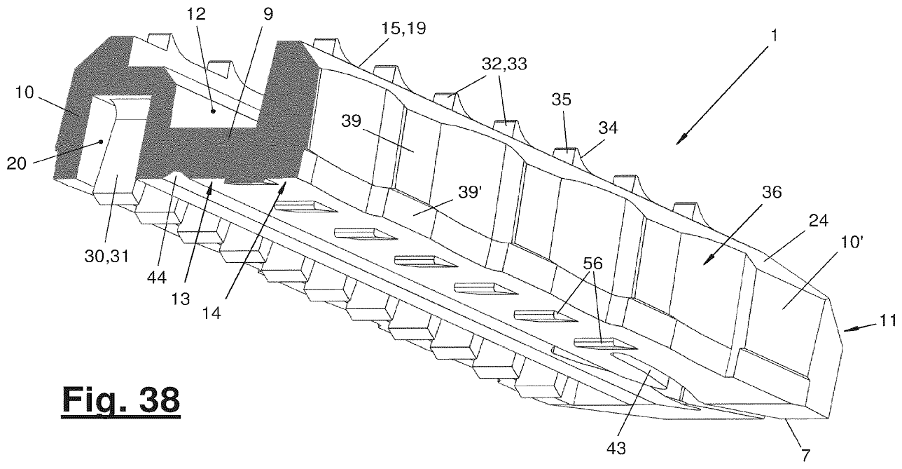

FIGS. 33-38 show a modification of the embodiment described above in FIGS. 24-32.

This modified variant largely corresponds to the embodiment described above in FIGS. 24-32. It differs primarily in the arrangement of one or more bottom elevations (56) and the possible arrangement of the elastic edge side upper restraining elements (32) on the upper free edge area (15) of the other sidewall (10′), as explained in the first embodiments.

FIGS. 33 and 34 show the plug connector (1) with the different sidewalls (10, 10′) in perspective views from below and above. FIG. 35 shows the plug connector (1) and the plug connection (45) in an enlarged front view. FIGS. 36 and 37 show the plug connector (1) in a side view and a top view. FIG. 38 shows a perspective cross-section of the plug connector (1) in an area of a connector shank (7) that is axially spaced from the connector center (6) and the bottom base (55).

In this variant, the other sidewall (10′) is also narrower and preferably solid than the other, hollow sidewall (10). In the variant shown in FIGS. 33-38, the aforementioned elastic edge side restraining elements (32) are arranged on the upper free edge area (15) of the other sidewall (10′). They protrude from the edge area (15) in a direction transverse to the main plane of the connector bottom (9) and preferably also have the aforementioned design as wedge shaped and spring elastic edge lugs (33) with the lug front (34) facing the front side (11) and the lug ridge (35) facing the connector center (6), (35). These additional edge side restraining elements (32) can be designed and arranged uniformly on both sidewalls (10, 10′).

The aforementioned one or more bottom elevations (56) are each arranged on the underside of the connector shanks (7, 8) and in the axial direction outside the bottom base (55). They are located on the bottom outer side (13) and/or on the underside (14) of the other sidewall (10′). This preferably flat underside (14) can be flush with the bottom outer side (13) of the base. As FIG. 34 illustrates, the one or more bottom elevations (56) can be arranged in the area of the transition between the connector bottom (9) and the other sidewall (10′).

In the embodiment shown, several local bottom elevations (56) are present on each of the connector legs (7, 8), which are arranged in a single row in the longitudinal direction (5) with a mutual distance between them.

The base elevations (56) each have a wedge shape that rises toward the connector center (6) and are designed as approach ramps. The one or more bottom elevations (56) extend up to the height of the outer side of the bottom based (55). FIG. 35 shows this in the front view of the plug connection (45). The bottom elevations (56) provide support for the plug connector (1) on the hollow profile bottom (46) in the area of the connector shank (7, 8). They can be designed to be sufficiently stiff for this purpose.

The design and arrangement of the one or more bottom elevations (56) can be modified. Instead of the series of individual local and wedge-shaped bottom elevations shown, there may be a rib-like bottom elevation that is shaped like a strip, extends in the longitudinal direction, and runs continuously over at least a large part of the leg length. Furthermore, it is possible to design the individual, local bottom elevations (56) to be rounded, e.g., hemispherical. A strip-shaped bottom elevation may have a slide on slope on the front side (11). These shapes facilitate the attachment of the hollow profile (2).

Modifications of the embodiments shown and described are possible in various ways.

The plug connector (1) with different sidewalls (10, 10′) shown in FIGS. 24 to 32 may be provided with the bottom elevations (56) on its underside.

The additional elastic edge side restraining elements (32) on the upper free edge area (15) of the sidewalls (10, 10′) may be omitted in the various embodiments.

FIG. 5 shows, in dashed lines, the arrangement of a local bridge or roof wall (53) spanning the hollow interior (12) and arranged in a fixed or detachable manner in the area of the connector center (6). Here, the plug connector (1) has a locally closed circumference and an axially permeable hollow interior (12). A roof wall (53) can connect to the free upper edge area (15) of the sidewalls on both sides. A bridge (53) can have an inverted U-shape and can be loosely or firmly inserted into the interior space (12). The bridge or roof wall (53) can be fitted closely to the profile roof (47) on the outer side. A sealing material can also be arranged on the outer side of the bridge or roof wall (53).

As an alternative to the straight connectors shown, the plug connector (1) can be designed as a corner angle. Herein, the connector shanks (7, 8) are angled relative to each other, e.g., by approx. 90°. The center stop (26) is modified accordingly and provides defined stop edges for the front sides of the attached hollow profiles (2). The corner angle can also have a closed design on the outer side in the corner area.

In addition, the features of the various embodiments and the aforementioned modifications can be combined with each other as desired within the scope of the claims.

While specific embodiments of the invention have been shown and described in detail to illustrate the application of the principles of the invention, it will be understood that the invention may be embodied otherwise without departing from such principles.

1. A plug connector or hollow profiles, of a spacer of an insulating glazing, wherein the plug connector has a longitudinal direction as well as a connector center and, extending therefrom on both sides, longitudinally extended connector shanks wherein the plug connector has, at least in some areas, a substantially U-shaped cross-section with open front sides and an inner hollow interior space, the plug connector further comprising:
a connector bottom on an underside; and which sidewalls extend upward transversely to a main plane of the connector bottom, each sidewall having an outer side and an inner side facing the interior space, wherein at least one of the sidewalls is of a hollow configuration and comprises an inner cavity open towards the connector bottom; and
lamella-shaped, spring-elastic lower restraining elements, which are arranged in the inner cavity, and projecting beyond an outer side of the connector bottom, wherein at least one of the sidewalls has, on an outer side thereof, a longitudinally extending, laterally protruding corrugated rib contour with obliquely flattened rib crests.

2. (canceled)

3. The plug connector according to claim 1, wherein the corrugated rib contour is formed by a plurality of corrugated ribs arranged one behind the other in the longitudinal direction, and molded onto the sidewall and projecting laterally, each of the corrugated ribs having a slanted flattening at a rib crest and wherein the flattening rises obliquely outwards towards the connector center.

4. (canceled)

5. The plug connector according to claim 1 one of the preceding claims, wherein the corrugated rib contour extends over an entire length of the connector shanks and is interrupted in the area of the connector center.

6. The plug connector according to claim 3, wherein the slanted flattening is arranged between a rib front, which faces the adjacent front side of the plug connector and rises from the outer side, and a rib ridge of the corrugated rib, which faces the connector center and slopes towards the outer side and wherein the flattening, at a transition to the rib front and to the rib ridge, respectively, has an upright edge.

7-9. (canceled)

10. The plug connector according to claim 3, wherein the corrugated ribs each have an asymmetrical shape when viewed in plan view onto the connector bottom and wherein the rib front is longer than the flattening, and the latter is longer than the rib ridge.

11-12. (canceled)

13. The plug connector according to claim 6, wherein the rib front rises from the outer side at a slight first angle, the flattening rises less steeply at a second angle, and the rib ridge slopes steeply towards the outer side at a third angle and wherein the first angle is greater than the second angle and smaller than the third angle.

14-18. (canceled)

19. The plug connector according to claim 1, wherein the at least one of the one or both sidewalls in an area of the connector shanks has a cross-section that is open towards the underside, with a U-shaped box shape with the inner cavity, wherein the hollow box shape extends over substantially an entire length of the plug connector, and wherein the hollow box shape of the at least one sidewall or of both sidewalls is stiffened in the area of the connector center.

20-22. (canceled)

23. The plug connector according to claim 19, wherein the hollow box shape of the relevant at least one sidewall is formed by an inner wall, a spaced-apart outer wall, and an upper connecting transversal wall and wherein the corrugated rib contour is arranged on the outer side of the outer wall, and wherein the outer wall with the corrugated rib contour is configured to be spring elastic.

24-28. (canceled)

29. The plug connector according to claim 19, wherein the at least one hollow sidewall and the box shape in the area of the connector center have a stiffening, which is formed by one or more support blocks arranged in the cavity of the respective sidewall in an area of the connector center, wherein the one or more support blocks are each firmly connected to a transversal wall and are alternately connected to the inner wall and/or the outer wall of the respective sidewall via a support block connection.

30-35. (canceled)

36. The plug connector according to claim 1, wherein the at least one sidewall has a stepped outer cross-sectional shape, which is formed by a wide, sidewall base in the floor area and a narrow sidewall bar that projects from the upper side of the sidewall base in a direction transverse to the main plane of the connector bottom and wherein upper edge-side restraining elements are each formed as a wedge-shaped, spring elastic edge lugs, which are arranged on a flat upper wall of the sidewall bar.

37-42. (canceled)

43. The plug connector according to claim 1, wherein the plug connector is formed from a fiber-reinforced plastic.

44. (canceled)

45. The plug connector according to claim 1, wherein the plug connector is configured as a straight connector with mutually aligned connector shanks or as a corner angle with mutually angled connector shanks.

46. The plug connector according to claim 1, wherein the plug connector comprises a hollow interior space extending in the longitudinal direction between the connector bottom and the sidewalls, and has a roof wall or bridge in an area of the connector center connecting the sidewalls transversely.

47. The plug connector according to claim 1, wherein the sidewalls are configured differently, wherein one sidewall has a hollow configuration with lower restraining elements and with elastic upper restraining elements on the edge, and the other sidewall has a smaller width and a smaller height than the one sidewall and is preferably formed to be substantially solid.

48. (canceled)

49. The plug connector according to claim 47, wherein the plug connector has, on an outer side of the connector bottom, a bottom base projecting outward, which is arranged in an area of the connector center and extends into both connector shanks, the axial length of which is substantially smaller than the connector length wherein the bottom base extends, in a transverse direction, up to the outer side of the other sidewall and ends in front of the one hollow sidewall and the bottom-side restraining elements and wherein the other sidewall in the area of the bottom base, has on an underside thereof a narrow slit-shaped axial cavity which is open towards the outside on the bottom side.

50-56. (canceled)

57. A plug connection comprising
a hollow profile; and
a spacer of an insulating glazing receives an inserted plug connector, wherein the plug connector is configured to have a longitudinal direction and a connector center and, extending from the center on both sides, longitudinally extended connector shanks, wherein the plug connector has, at least in some areas, a substantially U-shaped cross-section with open front sides and an inner hollow interior space, and has on an underside a connector bottom as well as, on both longitudinal edges thereof, adjoining sidewalls which extend upward transversely to the main plane of the connector bottom, each sidewall having an outer side and an inner side facing the interior space, wherein one or both sidewalls are hollow and have, on an open underside, protruding, lamellar, resilient lower restraining elements which project beyond a floor outer side of the connector bottom, wherein the at least one sidewall has, on the outer side, a rib contour extending in the longitudinal direction and projecting laterally, each having obliquely flattened rib crests.

58. The plug connection according to claim 57, wherein the hollow profile made of metal and/or plastic and has a profile bottom, lateral profile walls, and a profile roof, wherein the connector bottom rests against the profile bottom and covers a front-side abutment portion of the hollow profile.

59-61. (canceled)

62. A plug connector for hollow profiles of a spacer of an insulating glazing, the plug connector comprising a longitudinal direction as well as a connector center and, starting therefrom, on both sides longitudinally extending connector shanks, wherein the plug connector has, at least in certain regions, a substantially U-shaped cross-section with open front sides and an internal hollow interior space, the plug connector further comprising:
a connector bottom on an underside;
adjoining sidewalls on both longitudinal edges of the connector bottom projecting upwardly transversely to the main plane of the connector bottom, each sidewall having an outer side and an inner side facing the interior space, wherein one sidewall or both sidewalls is or are of a hollow configuration and comprises or comprise an inner cavity open towards the connector bottom;
lamella-shaped, spring-elastic lower restraining elements arranged in the inner cavity, wherein the one or more sidewall, having the hollow configuration and inner cavity open towards the connector bottom has the spring-elastic lower restraining elements arranged therein and projecting beyond a bottom outer side of the connector bottom; and
further edge-side, elastic upper restraining elements, wherein one or both sidewalls have, at an upper free edge area thereof, facing away from the connector bottom, respectively the further edge-side, elastic upper restraining elements, which project in a direction transverse to the main plane of the connector bottom.

63. The plug connector according to claim 62, wherein one or both sidewall has, on its outer side, a corrugated rib contour extending in the longitudinal direction and projecting laterally, each corrugated rib contour having obliquely flattened rib crest.

64. The plug connector for hollow profiles of a spacer of an insulating glazing, wherein the plug connector comprises a longitudinal direction as well as a connector center and, starting therefrom, on both sides longitudinally extending connector shanks, wherein the plug connector has, at least in certain regions, a substantially U-shaped cross-section with open front sides and an inner hollow interior space, the plug connector further comprising:
a connector bottom on an underside;
adjoining sidewalls on both longitudinal edges of the connector bottom, the sidewalls projecting upwardly transversely to the main plane of the connector bottom, each sidewall having an outer side and an inner side facing the interior space, wherein the sidewalls comprise a hollow configuration sidewall with an inner cavity open towards the connector bottom; and
lamella-shaped, spring-elastic lower restraining elements arranged in the inner cavity and projecting beyond a bottom outer side of the connector bottom, wherein the sidewalls are differently configured, wherein the hollow configuration sidewall is configured for edge-side elastic upper restraining elements, wherein the other sidewall has a smaller width than the hollow configuration sidewall and a smaller height than the hollow configuration sidewall and is of substantially solid configuration.

65. The plug connector according to claim 64, wherein the plug connector having a width of 12 mm or less.
